(19) United States
(12) Patent Application Publication
(10) Pub. No.: US 2005/0045045 A1
(43) Pub. Date: Mar. 3, 2005

(54) Grill grate logo transfer apparatus

(76) Inventor: Daniel B. Sullivan, Durham, NC (US)

Correspondence Address: GREG GOSHORN, P.C., 2110 SLAUGHTER LANE, SUITE 115-119, AUSTIN, TX, 78748, US

(21) Appl. No.: 10/650,554

(22) Filed: Aug. 28, 2003

(51) Int. Cl. A47J 37/08

(52) U.S. Cl. 99/388

(57) ABSTRACT

Provided is a cooking surface that incorporates a reverse-image decorative design so that when a foodstuff is prepared on the cooking surface, the design is transferred to the foodstuff. When the foodstuff is placed on the cooking surface, the foodstuff rests upon the decorative design element. A heat source applied to the cooking surface cooks the foodstuff such that, when food stuff is finished cooking, an image of the design element is displayed upon the foodstuff. By means of the present invention, a restaurant can impress, or “print,” a logo or message upon a steak, hamburger or other food product. A business owner can display a trademark on a food product for promotional purposes, a parent can place a cartoon character on a child's meal to encourage the child to eat the meal, and a stadium owner can place a local sport team's logo on a hamburger or hot dog.

### BACKGROUND OF THE INVENTION

1. Technical Field

The invention relates generally to an apparatus for and method of cooking food and, more specifically, to a device for transferring words or symbols onto food products while cooking.

2. Description of the Related Art

Every day, in homes or restaurants, food is cooked and served to the world's population. One popular form of cooking is grilling, which uses a cooking grate placed over a heat source such as a fire. The fire is ignited and the food to be cooked is typically placed on the cooking grate, which is then positioned over the fire. The heat from the fire cooks the food and, in the process, often leaves a darkened pattern consisting of a series of parallel lines corresponding to wire components of the grate.

Recently, manufacturers have been marketing indoor electric grills in which the grate is composed of a cooking surface that has a series of parallel ridges alternating with troughs and a non-stick surface. Examples of this type of grill are the George Foreman Grill® and similar products produced by Black and Decker®, Sunbeam®, General Electric® and others. In these types of grills, the parallel ridges on the cooking surface leave a darkened pattern on food cooked upon them.

Consumers can purchase “branding irons” that imprint a design upon foodstuffs (usually grilled). However, marking food with a branding iron is both awkward and inconvenient. To use a branding iron, the iron must first be heated by placing the iron on a heat source such as a fire. Grills and other food preparation appliances typically do not include a convenient location for the heating a of branding iron. Additionally, irons may be expensive and are an added cost, rather than being included in the cost of a cooking appliance.

Cake pans are available that include a reverse design so that, when a cooked cake is removed from the pan, the design is displayed on the top of the cake. These cake pans create the design by forming the food into the shape of the design rather than creating the design by changing the color of, or darkening, areas of the food.

### SUMMARY OF THE INVENTION

Provided is a cooking surface that incorporates a reverse image of a decorative design element such as, but not limited to, a logo, so that when a foodstuff such as a steak or hamburger is prepared on the cooking surface, the design is transferred to the foodstuff. For example, a reverse image of a business logo is incorporated into a grill grate, so that when the foodstuff is removed from the grate after cooking, the logo is imprinted upon the food and appears in forward view. Although applicable to a wide variety of foodstuffs, for the sake of convenience, the following examples will refer to the cooking of hamburgers.

Typically, to cook a hamburger, a patty of ground beef is placed upon a cooking surface, which can be, but is not limited to, a solid piece of material or a wire grate made of a number of parallel metal rods fastened together. A heat source such as electricity, gas or charcoal is ignited below the cooking surface and the heat source cooks the hamburger. In the case of the wire grate, the energy of the heat source is transferred to the hamburger more efficiently through the parallel metal rods than through the heat source itself. Thus, the hamburger, when cooked, is darken in the places where it has rested upon the parallel metal rods. Using this principle, the present invention provides a reverse-image design element either flush with the parallel rods or slightly raised from the cooking surface such that the foodstuff rests upon the pattern while cooking and, when the hamburger or other food stuff is finished cooking, an image of the design element is displayed upon the hamburger.

By means of the present invention, a restaurant can print a logo or message upon a steak, hamburger or other food product. For example, a Chinese restaurant can place a fortune cookie-like saying upon an eggplant or egg roll and a consumer can place a family crest upon a grilled cheese sandwich. The present invention enables, among other things, a business owner to display a trademark on a food product for promotional purposes, a parent to place a cartoon character on a child's meal to encourage the child to eat the meal, and a stadium concessionaire can place a local sport team's logo on a hamburger or hot dog. Particular types of food may even have warning labels imprinted, e.g. “This hamburger may contain more than the Food and Drug Administration recommended daily allowance of fat.”

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 illustrates a cooking grate for use on an outdoor grill incorporating the claimed subject matter.

FIG. 2 illustrates a second cooking grate incorporating another embodiment of the claimed subject matter.

FIG. 3 illustrates a third cooking surface incorporating the claimed subject matter suitable for an indoor-type grill.

FIG. 4 illustrates a partial side-on view of the cooking surface described in conjunction with FIG. 3.

### DETAILED DESCRIPTION

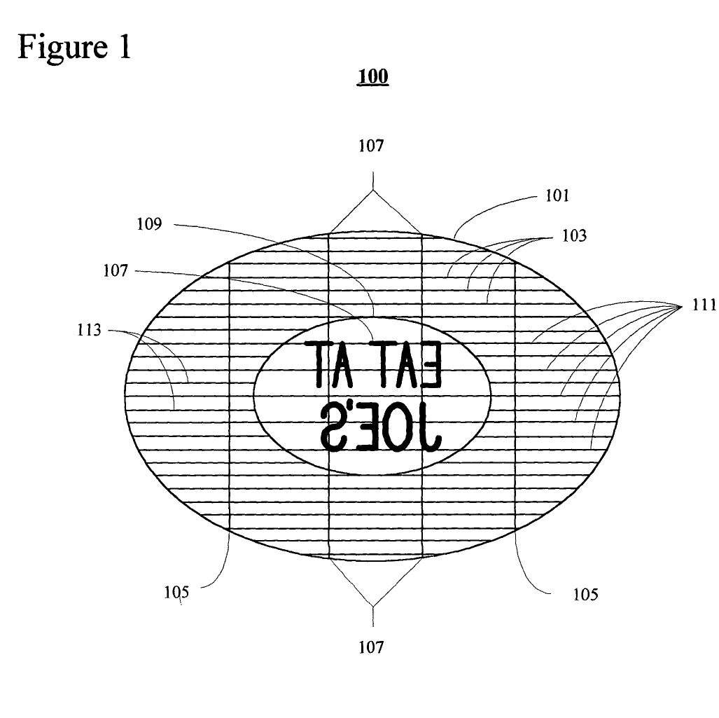

Turning now to the figures, FIG. 1 illustrates a cooking grate 100 for use on a grill (not shown) incorporating the claimed subject matter. Cooking grate 100 is made of parallel wires 103 which extend from one side to the other of a circular or oval shaped wire rim 101. For the sake of simplicity, all wires 103 are not numbered in the diagram. Perpendicular to wires 103 are wires 105, which also extend from one side of rim 101 to the other side. At the points where wires 103 cross wires 105, the corresponding wires are welded or otherwise fastened together. The individual welds provide structural support for cooking grate 100. Additional parallel wires 111 and 113, and two wires 107 perpendicular to wires 111, extend from rim 101 to an inner rim 109. Some or all of wires 111 and 113, e.g., in this figure, wires 113, and 107 may extend through and out the other side of inner rim 109, extending to the opposite edge of rim 101.

Incorporated into inner rim 109 is an exemplary commercial symbol 107, in this case, the phrase “EAT AT JOE'S.” It should be noted that symbol 107 is a reverse image so that markings it creates on food stuffs can be easily read. Symbol 107 is made of the same or similar type of material as wires 105, 107, 111 and 113 and rims 101 and 109. Symbol 107 is welded or otherwise affixed to any wires 111 which extend through inner rim 109. In addition, symbol 107 is either at the same level as wires 105, 107, 111 and 113 or slightly raised so that the foodstuff, when placed upon the grate 100, rests upon symbol 107.

Of course, symbol 107 may be made of any suitable material appropriate for a cooking surface, as can wires 105, 107, 111 and 113. In addition, a wide variety of words, symbols, logos, and designs can be incorporated in place of “EAT AT JOE'S” symbol 107. For example, a sport team's logo, a cartoon character or a trademark can be used in the claimed subject matter. Inner rim 109 could also be eliminated and a symbol such as symbol 107 can be simply incorporated into a standard cooking grate, which should be familiar to those with experience with outdoor-type grills. It is also not necessary for cooking grate 100 to be oval or circular or for grate 100 to be for an outdoor-type grill, for example, the claimed subject matter can be incorporated into a standard rectangular grate found on a kitchen stove top or a kitchen oven.

When a foodstuff is placed upon grate 100, positioned over symbol 107 and a heating source is applied to grate 100 and the food stuff, an image of symbol 107 is created on the foodstuff. For example, a steak (not shown) prepared on grate 100 in the proper position, i.e. on top of symbol 107, would, when cooked, display the phrase “EAT AT JOE'S.”

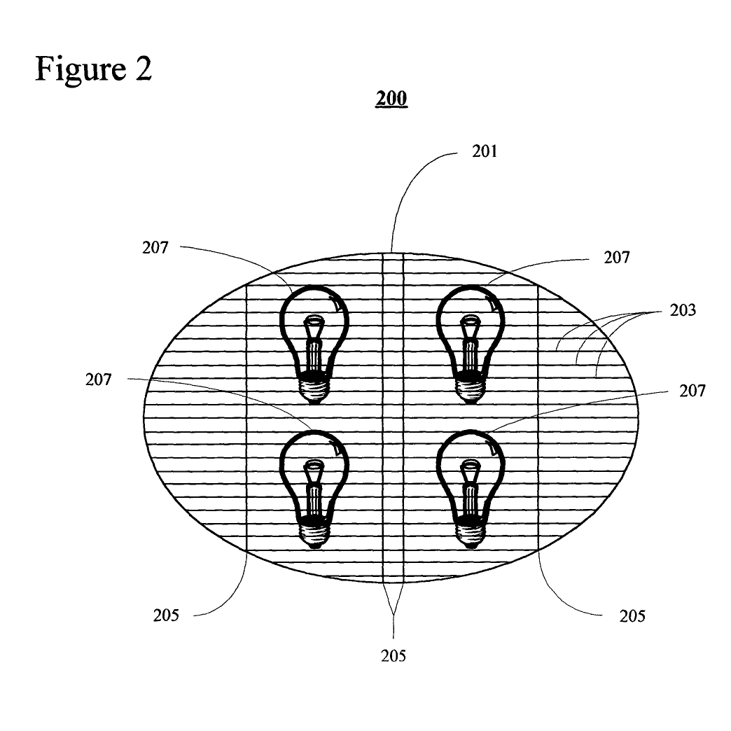

FIG. 2 illustrates a second cooking grate 200 incorporating another embodiment of the claimed subject matter. Grate 200 is made of wires 203, 205 and 207, similar to wires 111, 105 and 107 of grate 100 (FIG. 1). Grate 200 also has an outer rim 201 similar to rim 101 of grate 100. Also included in grate 200 are four design elements 207 that are made of a material similar to wires 203, 205 and 207. In this example, the design element represents a light bulb but can easily be a word, phrase, logo, trademark, cartoon figure or some other design.

In this example, a cook can position four hamburgers (not shown) on grate 200, each over one of design elements 207 and, when the burgers are cooked, each would have a design of a light bulb imprinted upon their surface.

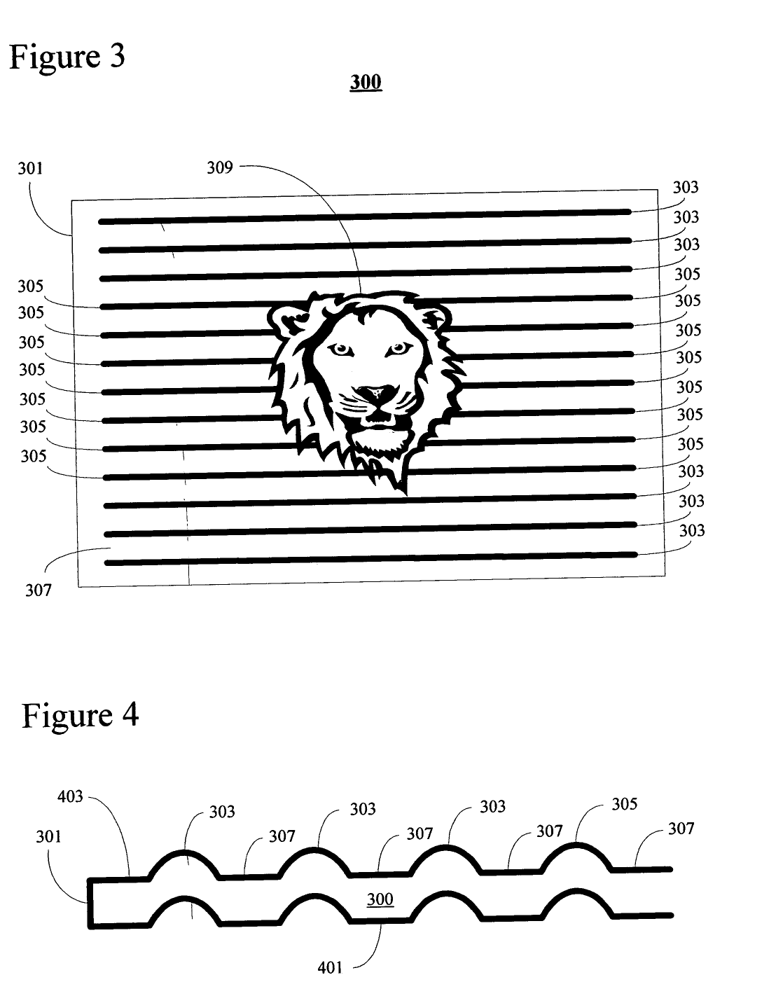

FIG. 3 illustrates a third cooking surface 300 incorporating the claimed subject matter that is suitable for an in-door type grill. Cooking surface 300 is a removable, non-stick surface that might fit into a George Foreman® Grill or any similar indoor, electric grill. In the alternative, cooking surface 300 may be incorporated into a range top. Slightly raised, parallel ridges 303 extend nearly from one end of cooking surface 300 to the other end. Other slightly raised ridges 305 extend from one end of cooking surface 300 to a decorative design element 309, in this example a cartoon-like lion character. In between ridges 303 and 305 are parallel troughs, for example trough 307. The surface (dark areas) of design element 309 is flush with the tops of ridges 303 and 305. In the alternative, design element 309 may be slightly raised above ridges 303 and 305. An edge 301 of cooking surface 300 is shown in more detail below in conjunction with FIG. 4.

When a foodstuff (not shown) such as a hamburger or steak is placed upon cooking surface 300, the foodstuff rests upon ridges 303 and 305 and design element 309. A heat source (not shown) then cooks the foodstuff and, in the process, causes a reverse image of design element 309 to be imprinted upon the foodstuff.

FIG. 4 illustrates a partial side-on view of cooking surface 300 from edge 301 described above in conjunction with FIG. 3. Ridges 303 and 305 are higher that troughs 307 such that, when a foodstuff is placed upon cooking surface 300, the foodstuff rests upon ridges 303 and 305 and design element 309 (FIG. 3). In this example, the bottom 401 of cooking surface 300 is shaped similarly to the upper surface 403. In an alternative embodiment, bottom surface 401 may be flat.

While various embodiments of the application have been described, it will be apparent to those of ordinary skill in the art that many more embodiments and implementations are possible that are within the scope of this invention. Accordingly, the invention is not to be restricted except in light of the attached claims and their equivalents.

1. A apparatus for cooking foodstuff, comprising:
a cooking surface; and
a reverse-image, decorative design element incorporated into the cooking surface, wherein a foodstuff placed upon the cooking surface rests upon the decorative design element such that an image of the decorative design element is imprinted upon the foodstuff when a heat source is applied to the cooking surface.

2. The apparatus of claim 1, wherein the decorative design element is a company logo.

3. The apparatus of claim 1, wherein the decorative design element is a sports team logo.

4. The apparatus of claim 1, wherein the decorative design element is a one or more words.

5. The apparatus of claim 1, wherein the decorative design element is a picture.

6. The apparatus of claim 1, wherein the cooking surface is a grill grate of an outdoor grill and the heat source is based upon combustion.

7. The apparatus of claim 1, further comprising:
an electric grill that incorporates the cooking surface.

8. A cooking device, comprising:
a heat source;
a cooking surface that is raised by the heat source to a temperature suitable for cooking a foodstuff; and
a reverse-image, decorative design element incorporated into the cooking surface, wherein the foodstuff rests upon the decorative design element when placed upon the cooking surface such that an image of the decorative design element is imprinted upon the foodstuff when the heat source is applied to the cooking surface.

9. The cooking device of claim 8, wherein the heat source is electrical.

10. The cooking device of claim 8, wherein the heat source is based upon combustion.

11. The cooking device of claim 8, wherein the decorative design element is a business logo.

12. The cooking device of claim 8, wherein the decorative design element is a sports team logo.

13. The cooking device of claim 8, wherein the decorative design element is one or more words.

14. The cooking device of claim 8, wherein the decorative design element is a cartoon-like character.

15. A method for imprinting a decorative design element upon a food stuff, comprising the steps of:
placing the foodstuff on a cooking surface that incorporates a reverse image of the decorative design element such that the foodstuff rests upon the reverse image; and
applying a heat source to the cooking surface.

16. The method of claim 15, wherein the decorative design element is a business logo.

17. The method of claim 15, wherein the decorative design element is a sports team logo.

18. The method of claim 15, wherein the decorative design element is one or more words.

19. The method of claim 15, wherein the decorative design element is a cartoon-like character.

20. The method of claim 15, wherein the heat source is based upon combustion.

21. The method of claim 15, wherein the heat source is electrical.
